(19) United States
(12) Patent Application Publication
(10) Pub. No.: US 2010/0016045 A1
(43) Pub. Date: Jan. 21, 2010

(54) BELTED GRAIN TANK FLOOR

(76) Inventors: Bruce A. Coers, Hillsdale, IL (US); Daniel J. Burke, Cordova, IL (US); Ryan P. Mackin, Milan, IL (US); Shane Anderson, Syracuse, UT (US); David Rix, Sandy, UT (US)

Correspondence Address: Taylor & Aust, P.C/Deere & Company, P.O. Box 560, Avilla, IN, 46710, US

(21) Appl. No.: 12/173,583

(22) Filed: Jul. 15, 2008

(51) Int. Cl. A01F 12/46

(52) U.S. Cl. 460/114

(57) ABSTRACT

A grain tank on a crop harvester includes a belted conveyor floor for moving grain in the grain tank toward an opening through which the grain tank is emptied.

### FIELD OF THE INVENTION

The present invention relates to agricultural harvesters, and, more particularly to grain tanks in such harvesters.

### BACKGROUND OF THE INVENTION

Agricultural harvesters, such as combines, include a head and a feeder housing which remove the crop material from the field, gather the crop material and transport the crop material to a separator in the harvester. The separator removes the grain crop material from the non-grain crop material. The grain is cleaned and deposited in a grain tank on the harvester. When the grain tank becomes full, the combine is positioned adjacent a vehicle into which the grain is to be unloaded, such as a semi-trailer, gravity box, straight truck, or the like; and an unloading system on the combine is actuated to transfer the grain into the vehicle.

It is known to provide a door at the bottom of a grain tank on a harvester and a conveyor adjacent to the door opening for transporting grain from the grain tank to an auger also on the harvester, for subsequent transport by the auger to the vehicle. It is known to drain the grain by gravity flow from the grain tank onto the conveyor. It is known to slope the walls and the floor of the grain tank to promote gravity flow of the grain through the door opening.

A trend in agricultural machines is for the size of the machines to become larger, reducing the number of passes required to cover a field. As the harvester width is increased, more grain is harvested during each pass over the field. Accordingly, it is desirable to increase the grain tank capacity to maximize productive crop harvesting time between unloading events. In many situations it is necessary to stop the harvester for unloading. Accordingly, it is desirable to reduce the frequency of unloading and to increase unloading efficiency to minimize the time required for unloading, and thereby maximize harvesting efficiency.

Providing sloped sides and a sloped floor reduces the grain tank storage volume for the footprint of the grain tank on the harvester. Grain tank capacity can be increased by simply increasing the height of the grain tank. However, this raises the center of gravity, which is undesirable.

Unloading by gravity flow can be unreliable and inefficient. The grain tanks do not always empty completely, and it may be necessary to clean the grain tank manually when switching between different crops. Further, as the grain tank empties, the discharge rate from the grain tank decreases, and considerable time may be required to remove a small volume at the end of the emptying cycle when emptying the grain tank by gravity flow.

What is needed in the art is a grain tank on a harvester with increased capacity for the footprint of the grain tank on the harvester, and a grain tank that empties quickly and reliably.

### SUMMARY OF THE INVENTION

The present invention provides a grain tank with an active floor that can be actuated to transport grain in the grain tank toward the door opening in the grain tank.

The invention in one form is directed to a grain tank for an agricultural crop harvester having a plurality of sides defining a space in which grain is accumulated. A door is operable in an opening of the grain tank in one of the sides to selectively cover and uncover the opening. An active floor between the sides is selectively operable to transport grain on the floor toward the opening.

The invention in another form is directed to a method for emptying a crop harvester grain tank. The method has steps of: opening a door near the bottom of the grain tank; draining grain from the grain tank by gravity flow through the open door; operating an active floor at the bottom of the grain tank; and moving grain toward the open door by operating the active floor.

The invention in still another form is directed to a crop harvester with a harvesting head and a body in which a crop is processed. A grain tank on the body receives processed grain. An opening is provided in the grain tank, and a door on the grain tank is operable to cover and uncover the opening. A conveyor adjacent the opening moves grain received through the opening away from the grain tank. An active floor in the grain tank moves grain in the grain tank toward the opening.

### BRIEF DESCRIPTION OF THE DRAWINGS

FIG. 1 is a perspective view of an agricultural harvester which includes an embodiment of a belted grain tank floor of the present invention;

FIG. 2 is a fragmentary perspective view of the top of the harvester shown in FIG. 1;

FIG. 3 is a perspective view of a grain tank having a belted floor in accordance with the present invention;

FIG. 4 is a cross-sectional view of the grain tank shown in FIG. 3, illustrating the grain tank open for emptying; and

FIG. 5 is a cross-sectional view similar to that of FIG. 4, but illustrating the door of the grain tank closed.

### DETAILED DESCRIPTION OF THE INVENTION

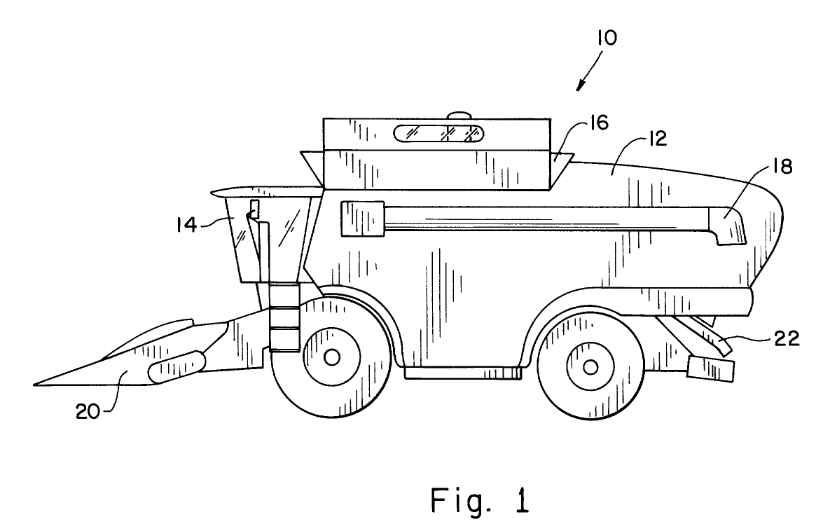

Referring now to the drawings, and more particularly to FIG. 1, there is shown an embodiment of an agricultural harvester 10. Harvester 10 generally includes a body 12, an operator cab 14, a grain tank 16 and an unloading auger 18. Harvester 10 is detachably coupled with a cutting platform or head 20 in front of operator cab 14. A crop material is removed from the field by head 20 and transported from head 20 into a separator within harvester 10. The grain is separated from the non-grain or refuse crop material, with the grain being transported into grain tank 16 and the non-grain refuse crop material being discharged back onto the field via a straw chopper 22.

Grain tank 16 receives grain from an auger 24, and may include a plurality of covers 26, 28 over the top thereof. A cross conveyor 30 at an end of grain tank 16 receives grain from grain tank 16 and transports the grain to unloading auger 18. FIG. 2 illustrates grain tank 16 in an opened condition to expose cross conveyor 30 during an unloading operation. An active floor 32 is provided in the bottom of grain tank 16 for active transport of grain thereon toward cross conveyor 30.

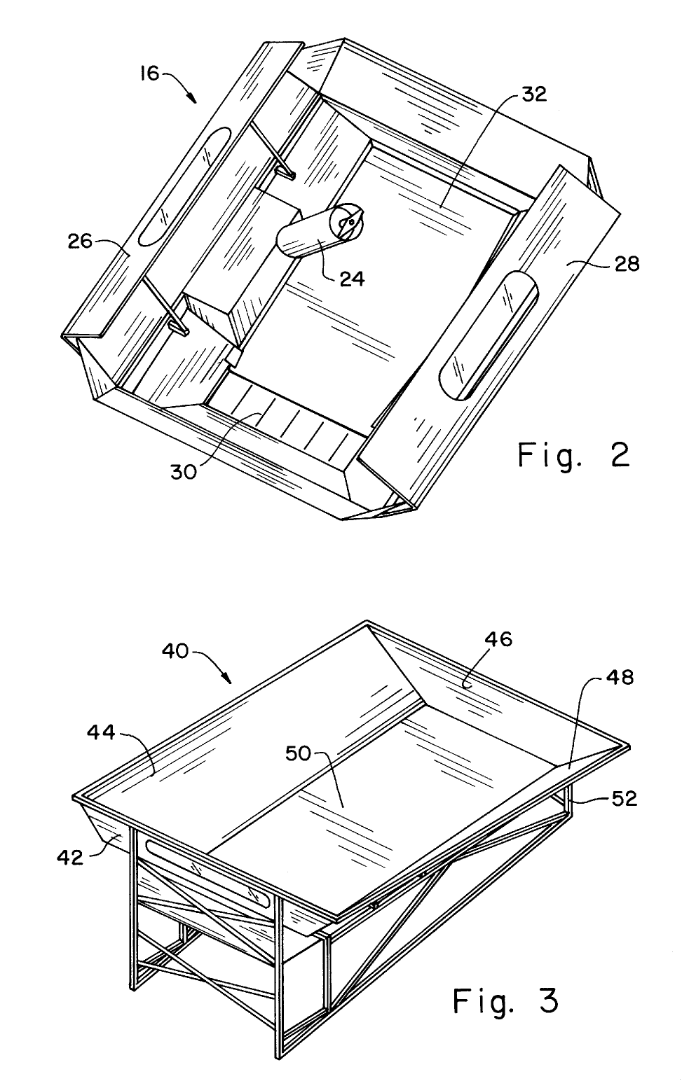

A simplified illustration of a grain tank 40 of the present invention is shown in FIG. 3. Grain tank 40 includes a plurality of side walls 42, 44, 46 and 48 defining a space for the receipt of grain therein. An active floor in the way of a belted conveyor floor 50 is provided at the bottom of grain tank 40 for actively transporting grain thereon. Other types of active floors also can be used, such as, for example, a drag chain. Grain tank 40 is supported in a harvester by a supporting framework 52 attached to harvester 10. Belted conveyor floor 50 forms the entire floor or bottom in grain tank 40, substantially spanning the entire area defined between the lower edges of side walls 42, 44, 46 and 48.

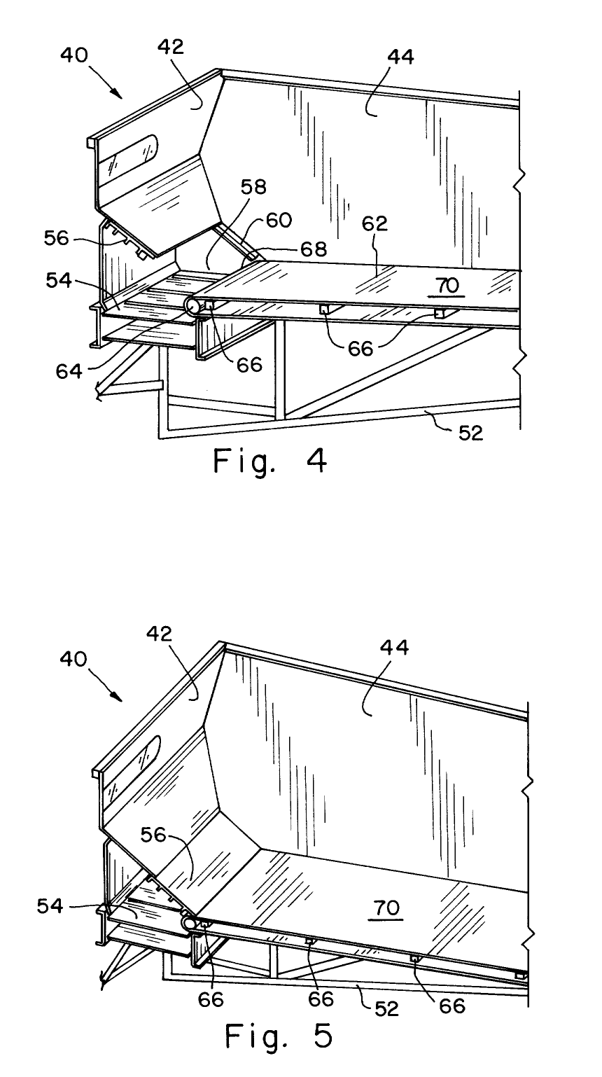

With reference now to the cross-sectional views of FIGS. 4 and 5, a cross conveyor 54 is provided at an end of grain tank 40. A door 56 is provided in an opening 58 through which grain flows from grain tank 40 to cross conveyor 54. Door 56 is a sliding door operable in channels 60, one of which can be seen in FIG. 4. It should be understood that a second channel similar to channel 60 is provided at the side of opening 58 opposite from the side illustrated in FIGS. 4 and 5.

Belted conveyor floor 50 is a looped endless belt conveyor having an endless belt 62 supported about rollers 64 and support members 66. Support members 66 span the distance from one side wall to an opposite side wall of tank 40, and are disposed between upper and lower runs of looped endless belt 62. Support members 66 provide support to endless belt 62 having grain loaded thereon.

Belted conveyor 50 extends through opening 58 and has a discharge end 68 thereof positioned over cross conveyor 54. As can be seen in FIG. 5, door 56 closes opening 58 and slides against an upper surface 70 of belt 62. Even if some grain slides between belt 62 and door 56, since discharge end 68 of belted conveyor floor 50 overlies cross conveyor 54, the grain will accumulate on cross conveyor 54 for subsequent transport to unloading auger 18 during a next unloading operation, and the grain, thereby, is not lost.

During an unloading operation, it is not necessary to operate an active floor of the present invention during the entire unloading process. The unloading operation is commenced by opening the door and draining grain from the grain tank by gravity flow through the door opening. For opening, the door is slid in the channels to uncover the opening and allow grain to drain from the grain tank by gravity flow. The grain tank discharge rate, which is the flow rate of grain from the grain tank, decreases as the grain tank empties. When the discharge rate decreases a significant amount, the active floor can be operated to transport grain thereon toward and through the grain tank opening to be dumped onto the cross-conveyor. Even only a slow, steady rotation of the endless belt will improve the grain tank emptying efficiency by actively moving the grain on the floor toward and through the door opening.

The walls of the grain tank can be angled inwardly slightly to promote flow and emptying; however, the walls need not be severely sloped nor need the floor be sloped toward the door opening. The active floor can be positioned substantially horizontally at the bottom of the sidewalls. Accordingly, in comparison to previously known grain tank designs with angled walls and an angled floor, the capacity of the grain tank of the present invention is increased without increasing the foot print of the grain tank on the harvester, and without increasing the grain tank height. Accordingly, capacity is increased while at the same time reducing the center of gravity in that the increased tank volume is achieved at the bottom of the grain tank. Since the grain in the grain tank is actively transported to the opening and does not rely completely on gravity drainage, emptying the grain tank is both efficient and thorough.

Having described the preferred embodiment, it will become apparent that various modifications can be made without departing from the scope of the invention as defined in the accompanying claims.

1-5. (canceled)

6. A method for emptying a crop harvester grain tank having fixed side walls, said method comprising the steps of:
opening a door in one of the fixed side walls, near the bottom of the grain tank, said door having an area less than the area of the one fixed side wall;
draining grain from the grain tank by gravity flow through the open door;
subsequently operating an active floor at the bottom of the grain tank; and
moving grain toward the open door by operating the active floor.

7. The method of claim 6, said step of operating an active floor including rotating an endless belt.

8. The method of claim 7, said step of rotating an endless belt commencing after emptying a portion of the grain tank by said step of draining.

9. The method of claim 6, said step of operating an active floor commencing after a discharge rate from draining grain from the grain tank by gravity flow begins to decline.

10. The method of claim 9, said step of operating an active floor including rotating an endless belt at the bottom of the grain tank.

11. The method of claim 6, said step of opening a door performed by sliding a door in a track.

12. A crop harvester, comprising:
a harvesting head and a body in which a crop is processed;
a grain tank on said body for receiving grain, said grain tank having a plurality of fixed side walls;
an opening in one of the side walls of said grain tank and a door operable to cover and uncover said opening, said opening having an area less than the area of the one fixed side wall;
a conveyor adjacent said opening to receive grain from said tank through said opening; and
an active floor in said grain tank for selectively moving grain in said grain tank toward said opening and for permitting flow of grain by gravity toward said opening.

13. The crop harvester of claim 12, said door comprising a sliding door.

14. The crop harvester of claim 12, said active floor comprising a rotatable endless belt.

15. The crop harvester of claim 14, said rotatable endless belt extending through said opening.

16. The crop harvester of claim 15, said rotatable endless belt having a discharge end over said conveyor.

17. The crop harvester of claim 15, said rotatable endless belt substantially spanning the area between said plurality of side walls in said grain tank.

18. The crop harvester of claim 12, said active floor substantially spanning the area between said plurality of side walls in said grain tank.

19. The crop harvester of claim 18, said active floor being a rotatable belt.

20. The crop harvester of claim 19, said rotatable belt disposed substantially horizontal.
